(19) United States
(12) Patent Application Publication
(10) Pub. No.: US 2025/0280424 A1
(43) Pub. Date: Sep. 4, 2025

(54) Enhancements for Dynamic Spectrum Sharing

(71) Applicant: Apple Inc., CUPERTINO, CA (US)

(72) Inventors: Haitong SUN, Saratoga, CA (US); Chunxuan YE, San Diego, CA (US); Dawei ZHANG, Saratoga, CA (US); Huaning NIU, San Jose, CA (US); Seyed Ali Akbar FAKOORIAN, San Diego, CA (US); Sigen YE, San Diego, CA (US); Wei ZENG, Saratoga, CA (US); Yushu ZHANG, Beijing (CN)

(21) Appl. No.: 18/858,852

(22) PCT Filed: Apr. 29, 2022
(86) PCT No.: PCT/CN2022/090606

§ 371 Date: Oct. 22, 2024

(51) Int. Cl. H04W 72/231; H04L 1/00; H04L 5/00; H04W 76/20

(52) U.S. Cl. CPC H04W 72/231; H04L 1/0067; H04L 5/0051; H04W 76/20

(57) ABSTRACT

A user equipment (UE) is configured to receive information associated with downlink reference signals for a first radio access technology (RAT), wherein the first RAT is different than a currently serving second RAT, identify reference signal occasions for the downlink reference signal and receive downlink control information (DCI) from the second RAT via a physical downlink control channel (PDCCH), wherein one or more DCI and one or more reference signal occasions occupy a same symbol.

### TECHNICAL FIELD

The present disclosure generally relates to communication, and in particular, to the enhancements for dynamic spectrum sharing.

### BACKGROUND

A network carrier may deploy fifth generation (5G) new radio (NR) services on top of the spectrum already being used for long term evolution (LTE) services. When multiple radio access technologies (RATs) share the same frequency bands a collision may occur between the signals of the different RATs. In this type of deployment scenario, dynamic spectrum sharing (DSS) technology may be utilized to ensure that 5G NR and LTE coexist while using the same spectrum. There is a need for techniques to ensure that a 5G NR physical downlink control channel (PDCCH) can coexist with LTE downlink reference signals.

### SUMMARY

Some exemplary embodiments are related to a processor of a user equipment (UE) configured to perform operations. The operations include receiving information associated with downlink reference signals for a first radio access technology (RAT), wherein the first RAT is different than a currently serving second RAT, identifying reference signal occasions for the downlink reference signal and receiving downlink control information (DCI) from the second RAT via a physical downlink control channel (PDCCH), wherein one or more DCI and one or more reference signal occasions occupy a same symbol.

Other exemplary embodiments are related to a user equipment (UE) having a transceiver configured to communicate with a network and a processor communicatively coupled to the transceiver and configured to perform operations. The operations include receiving information associated with downlink reference signals for a first radio access technology (RAT), wherein the first RAT is different than a currently serving second RAT, identifying reference signal occasions for the downlink reference signal and receiving downlink control information (DCI) from the second RAT via a physical downlink control channel (PDCCH), wherein one or more DCI and one or more reference signal occasions occupy a same symbol.

Still further exemplary embodiments are related to a processor of a base station configured to perform operations. The operations include identifying reference signal occasions for a downlink reference signal of a first radio access technology (RAT) and transmitting downlink control information (DCI) to a user equipment (UE) via a physical downlink control channel (PDCCH) of a second RAT, wherein one or more DCI and one or more reference signal occasions occupy a same symbol.

Additional exemplary embodiments are related to a base station having a transceiver configured to communicate with a user equipment (UE) and a processor communicatively coupled to the transceiver and configured to perform operations. The operations include identifying reference signal occasions for a downlink reference signal of a first radio access technology (RAT) and transmitting downlink control information (DCI) to a user equipment (UE) via a physical downlink control channel (PDCCH) of a second RAT, wherein one or more DCI and one or more reference signal occasions occupy a same symbol.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a method for physical data control channel (PDCCH) reception according to various exemplary embodiments.

FIG. 5 shows an example of a self-abstract syntax notation one (ASN.1) for a SearchSpace information element (IE) according to various exemplary embodiments.

FIG. 6 shows examples of exemplary LTE cell specific reference signal (CRS) design according to various exemplary embodiments.

FIG. 7 shows an example of physical downlink control channel (PDCCH) demodulation reference signal (DMRS) design according to various exemplary embodiments.

FIG. 8 shows examples of collision handling techniques for a collision between 5G NR PDCCH data and LTE CRS within a symbol according to various exemplary embodiments.

FIG. 9 shows examples of collision handling techniques for a collision between 5G NR PDCCH DMRS and LTE CRS within a symbol according to various exemplary embodiments.

### DETAILED DESCRIPTION

The exemplary embodiments may be further understood with reference to the following description and the related appended drawings, wherein like elements are provided with the same reference numerals. The exemplary embodiments relate to 5G new radio (NR) physical downlink control channel (PDCCH) transmission and reception. As will be described in more detail below, the exemplary embodiments introduce enhancements for dynamic spectrum sharing (DSS) between a long term evolution (LTE) radio access technology (RAT) and 5G new radio (NR) RAT.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

Those skilled in the art will understand that DSS refers to the deployment of multiple RATs in the same frequency band and the dynamic allocation of spectrum resources between those RATs. DSS may enable a network carrier to deploy 5G NR on top of the spectrum already being used for LTE. However, when multiple RATs share the same frequency band, a collision may occur between the signals of the different RATs. This may cause a performance degradation on the UE side and/or the network side for both LTE and 5G NR operations. While the exemplary embodiments are described with reference to a 5G RAT and an LTE RAT sharing spectrum, those skilled in the art will understand that the principles described herein may be implemented in any RATs that may share spectrum.

In accordance with various regulations and/or standards, DSS may be configured to ensure that LTE operations are not impacted by the presence of 5G NR communications in the same band. Since 5G NR communications are to be invisible to LTE operations, DSS may rely on 5G NR based mechanisms. For example, 5G NR PDCCH reception may include rate matching around LTE cell specific reference signals (CRSs). These types of mechanisms ensure backwards compatibility for legacy LTE UEs and allow the RATs to coexist in the same spectrum.

According to some aspects, the exemplary embodiments introduce techniques related to when or under what conditions rate matching around LTE CRS is to be performed for PDCCH reception. These restrictions enable an operator to satisfy DSS requirements and do not place unreasonable requirements on either the UE or the network. In another aspect, the exemplary embodiments introduce collision handling techniques for 5G NR PDCCH and LTE CRS. The exemplary techniques described herein may be used independently from one another, in conjunction with other currently implemented DSS mechanisms, future implementations of DSS mechanisms or independently from other DSS mechanism.

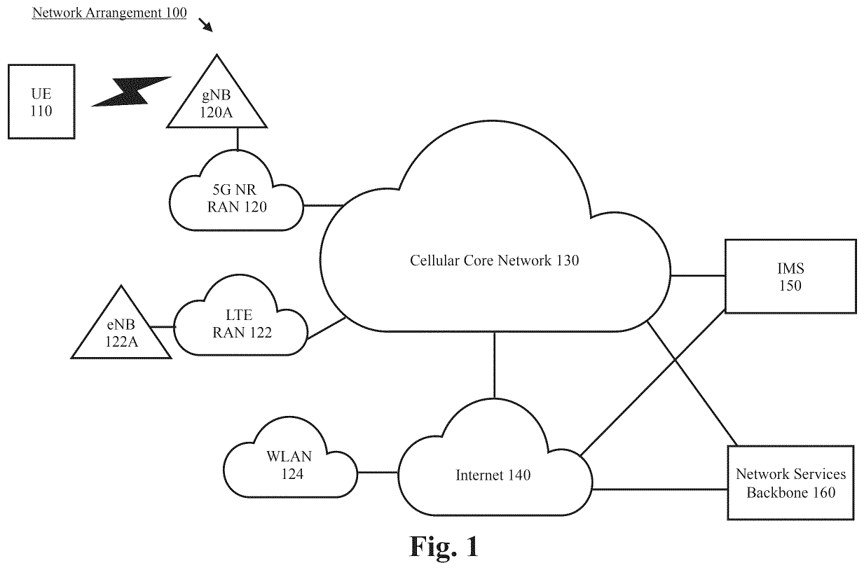

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120, an LTE RAN 122 and a wireless local area network (WLAN) 124. However, it should be understood that the UE 110 may also communicate with other types of networks (e.g., 5G cloud RAN, a next generate RAN (NG-RAN), a legacy cellular network, etc.) and the UE 110 may also communicate with networks over a wired connection. With regard to the exemplary embodiments, the UE 110 may establish a connection with the 5G NR RAN 120, the LTE RAN 122 and/or the WLAN 124. Therefore, the UE 110 may have a 5G NR chipset to communicate with the NR RAN 120, an LTE chipset to communicate with the LTE RAN 122 and an ISM chipset to communicate with the WLAN 124.

The 5G NR RAN 120 and the LTE RAN 122 may be portions of a cellular network that may be deployed by a network carrier (e.g., Verizon, AT&T, T-Mobile, etc.). The RANs 120, 122 may include cells or base stations that are configured to send and receive traffic from UEs that are equipped with the appropriate cellular chip set. In this example, the 5G NR RAN 120 includes the gNB 120A and the LTE RAN 122 includes the eNB 122A. However, reference to a gNB and an eNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.). The WLAN 124 may include any type of wireless local area network (WiFi, Hot Spot, IEEE 802.11x networks, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., the gNB 120A).

As mentioned above, the exemplary embodiments relate to DSS. Thus, reference to a single 5G NR RAN 120 and a single LTE RAN 122 is merely provided for illustrative purposes. In some embodiments, a single RAN may be configured to deploy both LTE RAT and 5G NR RAT. In other embodiments, there may be multiple RANs deployed with overlapping coverage areas. Similarly, reference to a single gNB 120A and a single eNB 122A is also provided for illustrative purposes. In some embodiments, a single base station or cell may be configured for both LTE RAT and 5G NR RAT. In other embodiments, multiple 5G NR base stations and multiple LTE base stations may be deployed with overlapping coverage areas. The exemplary embodiments are not limited to any particular arrangement of RANS and base stations. The exemplary embodiments may apply to any network arrangement that includes DSS functionality.

In addition to the RANs 120 and 122, the network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

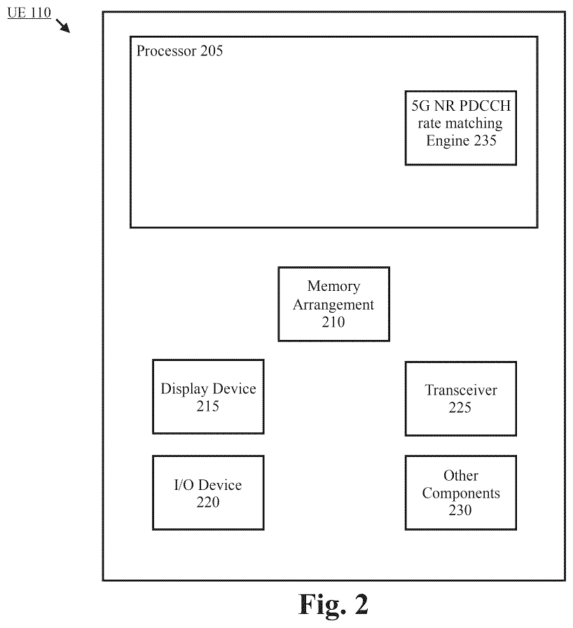

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a 5G NR PDCCH rate matching engine 235. The 5G NR PDCCH rate matching engine 235 may be configured to implement various exemplary rate matching techniques related to 5G NR PDCCH reception.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

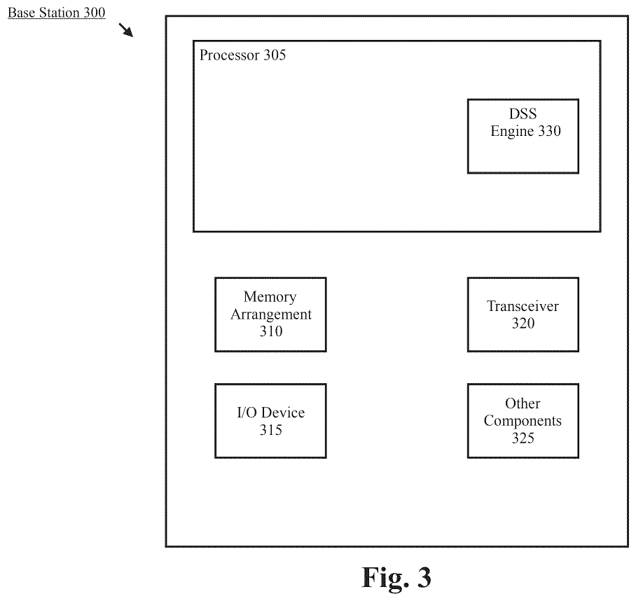

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines of the base station 300. For example, the engines may include a DSS engine 330. The DSS engine 330 may be configured to perform operations such as, but not limited to, transmitting configuration information for 5G NR PDDCH rate matching to the UE 110, transmitting on the PDCCH and puncturing PDCCH REs that collide with LTE CRS.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

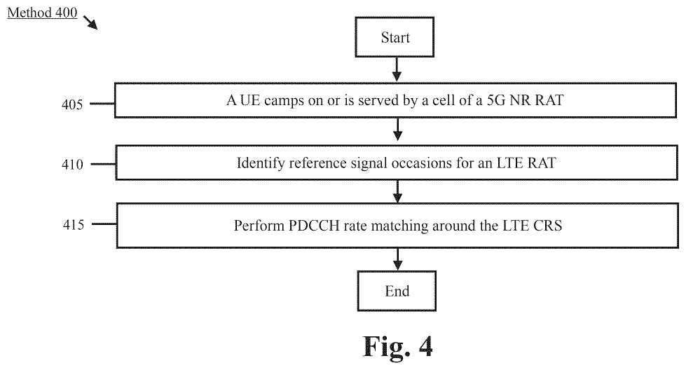

Initially, a general overview of an example scenario in which the UE 110 performs PDCCH rate matching is provided below with regard to the method 400 of FIG. 4. This example scenario provides context for various exemplary techniques introduced herein. Some of the exemplary techniques relate to when or under what conditions rate matching around LTE CRS is to be performed for PDCCH reception. Other exemplary techniques relate to collision handling for 5G NR PDCCH and LTE CRS.

FIG. 4 shows a method 400 for PDCCH reception according to various exemplary embodiments. The method 400 will be described with regard to the network arrangement 100 of FIG. 1 and the UE 110 of FIG. 2.

In 405, the UE 110 camps on or is served by a cell of a 5G NR RAT. For example, the UE 110 may connect to the gNB 120A of the 5G NR RAN 120. The 5G NR RAT may be deployed on the same frequency band as an LTE RAT. As a result, a deployment scenario may occur where 5G NR PDCCH is configured to use the same frequency band as LTE CRS.

In 410, the UE 110 identifies reference signal occasions for the LTE RAT. In other words, the UE 110 identifies the pattern (or rate) that is to be used by an LTE cell (e.g., eNB 122A) to transmit LTE CRS on the frequency band of the currently camped 5G NR cell.

The UE 110 may not be required to detect the existence and pattern of the LTE CRS that are to be transmitted on the same frequency band of the cell deployed by the gNB 120A. Instead, in some examples, coexistence information may be provided by the 5G NR cell that may explicitly or implicitly indicate the pattern (or rate) that will be used by the LTE cell to transmit LTE CRS. The coexistence information may enable the UE 110 to identify frequency and/or time locations on which one or more types of LTE downlink reference signals may be transmitted by an LTE cell (e.g., LTE CRS). The UE 110 may receive this coexistence information from the 5G NR cell during radio resource control (RRC) signaling or from any other appropriate source. Thus, a cell of a first RAT may provide coexistence information to the UE that is associated with a second different RAT. However, the exemplary embodiments are not limited to scenarios in which the UE 110 is explicitly or implicitly provided information from the network about the configuration of LTE CRS. The exemplary embodiments may collect information associated with the pattern (or rate) that is to be used by the LTE cell to transmit LTE reference signals from any appropriate one or more sources external or internal to the UE 110.

In 415, the UE 110 performs PDCCH rate matching around the LTE CRS. For example, the UE 110 may receive downlink control information (DCI) via the 5G NR PDCCH. Since the UE 110 is aware of the pattern (or rate) that is being used to transmit LTE CRS in the frequency band of the currently camped/serving 5G NR cell, the UE 110 may perform rate matching around the LTE CRS during 5G NR PDCCH reception. Those skilled in the art will understand that, generally, rate matching is a processing technique that includes de-mapping one or more symbols of a downlink signal and skipping the identified reference signal (e.g., LTE CRS) occasions during the de-mapping operation.

The UE 110 may configure the baseband processor to perform rate matching around LTE CRS based on certain conditions. Thus, the UE 110 may be configured to perform rate matching around LTE CRS when a first set of one or more conditions is satisfied and the UE 110 may be restricted from performing rate matching around LTE CRS when a second set of one or more conditions is satisfied. Specific examples of when and/or under what conditions the UE 110 is to perform rate matching around LTE CRS will be described in more detail below.

According to some aspects, 5G NR PDCCH rate matching for LTE CRS may be configured per NR search space. Those skilled in the art will understand that the UE 110 may be configured to receive 5G NR PDCCH in a particular search space. The search space may be a common search space (CSS) configured to be shared by multiple UEs or a UE specific search space (USS) configured on a per UE basis. The UE 110 may configure its baseband processor to perform rate matching around LTE CRS for 5G NR PDCCH reception when processing either a CSS or a USS. The examples provided below described various conditions related to different aspects of 5G NR search spaces that may provide the basis for the UE 110 deciding whether or not to perform PDCCH rate matching when processing a search space.

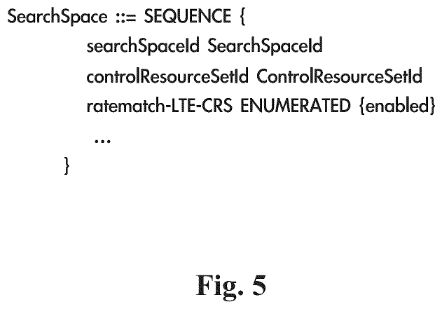

The UE 110 may be configured by the network to perform PDCCH rate matching when processing a particular search space. For example, the UE 110 may receive an RRC message from the gNB 120A comprising configuration information for different search spaces. The RRC message may include a “SearchSpace” information element (IE) that may define how/where the UE 110 is to search for PDCCH candidates. The exemplary embodiments introduce an indication for this SearchSpace IE that indicates whether PDCCH rate matching around LTE CRS is to be performed for the corresponding search space. FIG. 5 shows an example of a self-abstract syntax notation one (ASN.1) for a SearchSpace IE that may be used to configure the UE 110 to perform PDCCH rate matching around LTE CRS during PDCCH reception.

The RRC message may also include a PDCCH-Config IE and/or a PDCCH-ConfigCommon IE that may be used to configure PDCCH related operations at the UE 110. The exemplary embodiments introduce an indication to the PDCCH-Config IE and/or the PDCCH-ConfigCommon IE that indicates whether PDCCH rate matching around LTE CRS is to be performed for the corresponding search space. Alternatively, or in addition to the network configuration, the UE 110 may be preconfigured with predetermined rules that provide the basis for the UE 110 to determine whether or not to perform PDCCH rate matching on a particular search space. For example, the predetermined rules for PDCCH rate matching around LTE CRS may be hard encoded in various 3GPP Specifications. Accordingly, the exemplary embodiments may perform PDCCH rate matching around LTE CRS based on network configured parameters, preconfigured information, a combination thereof or any other appropriate factor.

In some embodiments, the UE 110 may be preconfigured with one or more of the following predetermined rules based on RRC parameters. For instance, as indicated above, the UE 110 may receive an RRC message comprising a SearchSpace IE. The contents of this IE may provide the basis for the UE 110 to determine whether or not to perform PDCCH rate matching during PDCCH reception on the corresponding search space. For a NR CSS, the UE 110 may restrict its baseband processor from performing PDCCH rate matching when a SearchSpaceType IE of the SearchSpace IE is configured as “common” or when a SearchSpaceType-r16 IE of the SearchSpace IE is configured as “common-r16.” For NR USS, the UE 110 may configure its baseband processor to perform PDCCH rate matching when a SearchSpaceType IE of the SearchSpace IE is configured as “ue-Specific.” These predetermined rules may be utilized for DSS without placing unreasonable requirements on either the UE or the network.

The network may also configure the UE 110 to perform PDCCH rate matching around certain LTE CRS patterns using coexistence information or any other appropriate type of configuration information. For example, the network may transmit configuration information comprising LTE CRS patterns to the UE 110 using RRC IEs such as “ServingCellConfig” and “ServingCellConfigCommon.” The exemplary embodiments introduce an IE that may be provided as part of the ServingCellConfig IE and/or the ServingCellConfigCommon IE that configures the UE 110 to perform PDCCH rate matching around one or more particular LTE CRS patterns. This exemplary IE may be implemented as “lte-CRS-ToMatchAround,” “lte-CRS-PatternList-r16,” “lte-CRS-PatternList2-r16,” or may be identified in any other appropriate manner. Thus, the UE 110 may configure its baseband processor to perform PDCCH rate matching around an LTE CRS pattern based on an indication provided in the LTE CRS pattern configuration information, e.g., ServingCellConfig, ServingCellConfigCommon, etc.

The network may configure more than one LTE CRS pattern at the UE 110 using RRC signaling. Subsequently, the network may utilize a MAC CE to dynamically activate and deactivate PDCCH rate matching for the configured LTE CRS patterns. This exemplary MAC CE may include a serving cell index, a bitmap comprising (N) bits where each bit corresponds to one LTE CRS pattern and zero or more reserved bits. If a bit of the bitmap is set to a first value (e.g., 1), the UE 110 may configure its baseband processor to perform PDCCH and/or PDSCH rate matching around the corresponding LTE CRS pattern. If a bit of the bitmap is set to a second value (e.g., 0), the UE 110 may configure its baseband processor to be restricted from performing PDCCH and/or PDSCH rate matching around the corresponding LTE CRS pattern. Thus, the UE 110 may configure its baseband processor to perform PDCCH rate matching around an LTE CRS pattern based on an indication provided in a MAC CE.

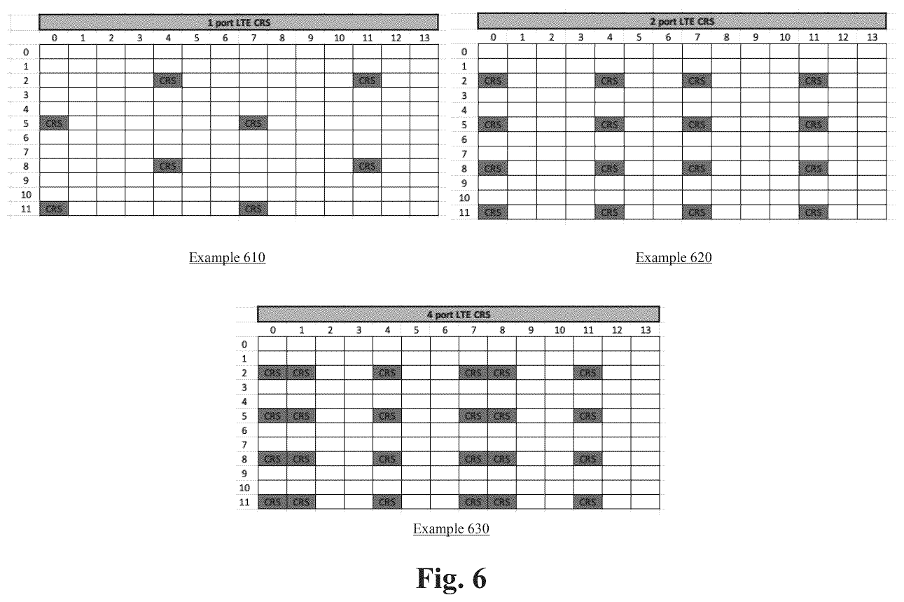

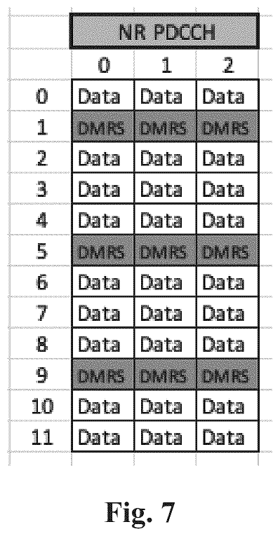

The exemplary embodiments also introduce collision handling techniques for 5G NR PDCCH and LTE CRS that may be implemented on the UE 110 side and/or gNB 120A side. Prior to discussing these exemplary techniques, a general overview of LTE CRS design and NR PDCCH design at the resource element (RE) level is provided below with regard to FIGS. 6-7.

FIG. 6 shows examples of exemplary LTE CRS design according to various exemplary embodiments. Example 610 illustrates a slot configuration of 1 port LTE CRS at the RE level, example 620 illustrates a slot configuration for 2 port LTE CRS at the RE level and example 630 illustrates a slot configuration for 4 port LTE CRS. Each of the examples 610-630 show a slot with symbols indexed 0-13 and subcarriers indexed 0-11.

The 1 port LTE CRS may occupy symbols {0, 4, 7, 11} of the slot and within each of these symbols, the CRS may be located every 6 REs. In example 610, the LTE CRS are shown as being located on subcarriers 5 and 11 of symbol 0, subcarriers 2 and 8 of symbol 4, subcarriers 5 and 11 of symbol 7 and subcarriers 2 and 8 of symbol 11. However, the exemplary embodiments are not limited to LTE CRS being arranged in this manner within the symbol. Thus, in actual operating scenarios, the subcarrier location of the CRS within the symbol may shift up or down but the number of REs between each CRS within the slot may be the same.

The 2 port LTE CRS may occupy symbols {0, 4, 7, 11} of the slot and within each of these symbols, the CRS may be located every 3 REs. In example 620, the LTE CRS are shown as being located on subcarriers 2, 5, 8 and 11 of symbol 0, subcarriers 2, 5, 8 and 11 of symbol 4, subcarriers 2, 5, 8 and 11 of symbol 7 and subcarriers 2, 5, 8 and 11 of symbol 11. However, the exemplary embodiments are not limited to LTE CRS being arranged in this manner within the symbol. Thus, in actual operating scenarios, the subcarrier location of the CRS within the symbol may shift up or down but the number of REs between each CRS within the slot may be the same.

The 4 port LTE CRS may occupy symbols {0, 1, 4, 7, 8, 11} of the slot and within each of these symbols, the CRS may be located every 3 REs. In example 630, the LTE CRS are shown as being located on subcarriers 2, 5, 8 and 11 of symbol 0, subcarriers 2, 5, 8 and 11 of symbol 1, subcarriers 2, 5, 8 and 11 of symbol 4, subcarriers 2, 5, 8 and 11 of symbol 7, subcarriers 2, 5, 8 and 11 of symbol 8 and subcarriers 2, 5, 8 and 11 of symbol 11. However, the exemplary embodiments are not limited to LTE CRS being arranged in this manner within the symbol. Thus, in actual operating scenarios, the subcarrier location of the CRS within the symbol may shift up or down but the number of REs between each CRS within the slot may be the same.

FIG. 7 shows an example of PDCCH demodulation reference signal (DMRS) design according to various exemplary embodiments. In this example, the PDCCH occupies 3 symbols indexed 0-2 and twelve subcarriers indexed 0-11. The DMRS is included in every PDCCH symbol and within each symbol, located every 4 REs. However, the exemplary embodiments are not limited to PDCCH DMRS being arranged in this manner within the symbol. Thus, in actual operating scenarios, the subcarrier location of the DMRS within the symbol may shift up or down but the number of REs between each CRS within the slot may be the same

Under conventional circumstances, an NR PDCCH candidate may not be expected to collide with LTE CRS and the UE 110 is not required to monitor NR PDCCH that collides with LTE CRS. It has been identified that in an actual deployment scenario, this type of behavior may restrict the 5G NR network from using 2 symbol and 3 symbol control resource sets (CORESETs), which may have a negative impact on NR scheduling flexibility and control reliability. According to some exemplary aspects, in contrast to the legacy approach, the exemplary techniques described below assume that the UE 110 is required to decode the corresponding PDCCH candidate. In addition, the exemplary embodiments support 5G NR PDCCH reception in symbols with LTE CRS.

When LTE CRS collides with NR PDCCH data within a symbol, the UE 110 may decode the corresponding PDCCH candidate. The UE 110 may identify this collision based on coexistence information, control information scheduling PDCCH data and/or any other appropriate factor. In some embodiments, on the network side, the gNB 120A transmits the PDCCH data even though it collides with LTE CRS within a symbol. While this may cause interference, it is unlikely to be severe enough to cause performance degradation.

In other embodiments, PDCCH data RE that collides with LTE CRS is punctured at the gNB 120A and thus, may not be actually transmitted. The UE 110 may perform rate matching and also puncture the PDCCH data within the symbol that collides with the LTE CRS. However, reference to puncturing is provided for illustrative purposes, different entities may refer to a similar concept by a different name. In addition, the exemplary embodiments are not limited to puncturing and may use any appropriate type of rate matching technique on the PDCCH data RE when it collides with the LTE CRS within a symbol.

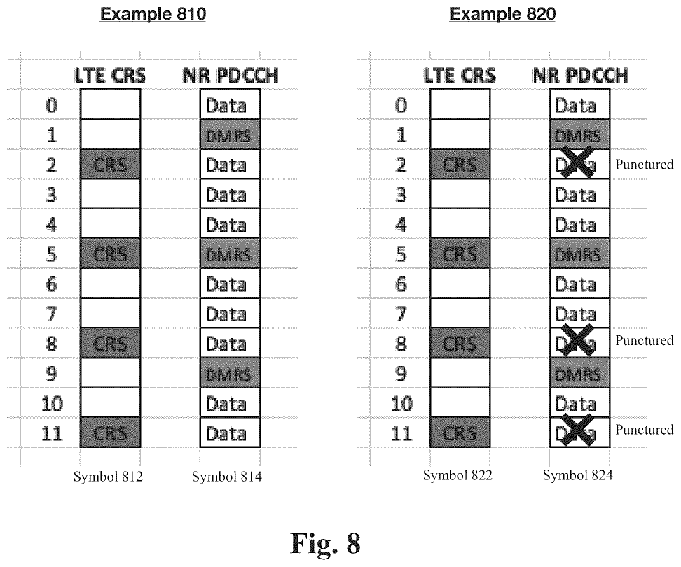

FIG. 8 shows examples of collision handling techniques for a collision between 5G NR PDCCH data and LTE CRS within a symbol according to various exemplary embodiments. In example 810, symbol 812 comprises LTE CRS occupying subcarriers 2, 8 and 11 and symbol 814 comprises NR PDCCH with PDCCH data and DMRS. Despite being depicted next to one another, the symbols 812 and 814 may be configured for transmission at the same time. In this example, the LTE CRS collides with PDCCH data. However, the NR PDCCH data is still transmitted by the gNB 120A and rate matching is not performed at the UE 110.

In example 820, symbol 822 comprises LTE CRS occupying subcarriers 2, 8 and 11 and symbol 824 comprises NR PDCCH with PDCCH data and DMRS. Despite being depicted next to one another, the symbols 822 and 824 may be configured for transmission at the same time. In this example, the LTE CRS collides with PDCCH data. The gNB 120A may puncture the PDCCH data that collides with the LTE CRS and thus, the punctured PDCCH data may not actually be transmitted to the UE 110. The UE 110 may also perform rate matching and puncture the PDCCH data that collides with the LTE CRS.

When LTE CRS collides with NR PDCCH DMRS within a symbol, the UE 110 may decode the corresponding PDCCH candidate. The UE 110 may identify this collision based on coexistence information, control information scheduling PDCCH data and/or any other appropriate factor. In some embodiments, on the network side, the gNB 120A transmits the PDCCH DMRS even though it collides with LTE CRS within a symbol. In other words, puncturing is not performed by the gNB 120A nor is rate matching/puncturing performed by the UE 110. While this may cause interference, it is unlikely to be severe enough to cause performance degradation.

In other embodiments, the PDCCH DMRS RE that collides with the LTE CRS is punctured at the gNB 120A and thus, may not be actually transmitted. The UE 110 may perform rate matching and also puncture the PDCCH DMRS within the symbol that collides with the LTE CRS. In further embodiments, when at least one PDCCH DRMS collides with LTE CRS, all of the PDCCH DMRS within the symbol may be punctured at the gNB 120A and the UE 110. However, reference to puncturing is provided for illustrative purposes, different entities may refer to a similar concept by a different name. In addition, the exemplary embodiments are not limited to puncturing and may use any appropriate type of rate matching technique on the PDCCH data RE when it collides with the LTE CRS within a symbol.

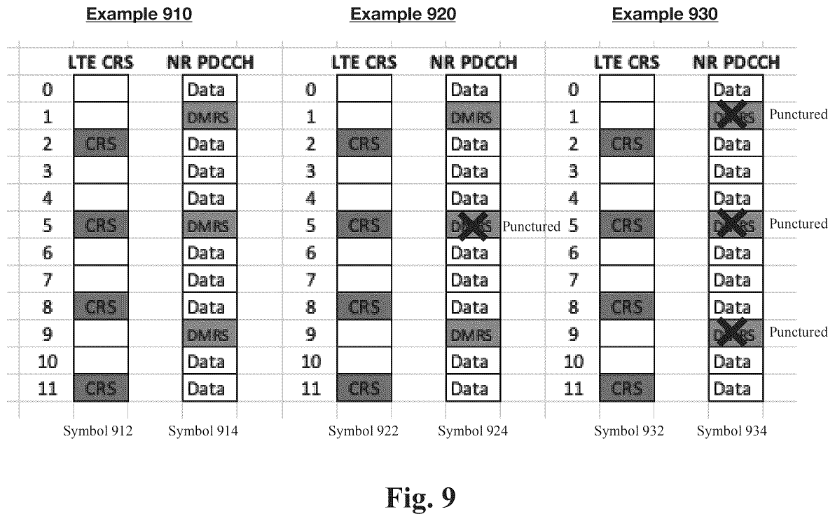

FIG. 9 shows examples of collision handling techniques for a collision between 5G NR PDCCH DMRS and LTE CRS within a symbol according to various exemplary embodiments. In example 910, symbol 912 comprises LTE CRS occupying subcarriers 2, 8 and 11 and symbol 914 comprises NR PDCCH with PDCCH data and DMRS. Despite being depicted next to one another, the symbols 912 and 914 may be configured for transmission at the same time. In this example, the LTE CRS collides with PDCCH DMRS. However, the NR PDCCH data is still transmitted by the gNB 120A and rate matching is not performed at the UE 110.

In example 920, symbol 922 comprises LTE CRS occupying subcarriers 2, 8 and 11 and symbol 924 comprises NR PDCCH with PDCCH data and DMRS. Despite being depicted next to one another, the symbols 922 and 924 may be configured for transmission at the same time. In this example, LTE CRS collides with a single PDCCH DMRS. The gNB 120A may puncture the PDCCH DMRS that collides with the LTE CRS and thus, the punctured PDCCH DMRS may not actually be transmitted to the UE 110. The UE 110 may also perform rate matching and puncture the PDCCH DMRS that collides with the LTE CRS.

In example 930, symbol 932 comprises LTE CRS occupying subcarriers 2, 8 and 11 and symbol 923 comprises NR PDCCH with PDCCH data and DMRS. Despite being depicted next to one another, the symbols 932 and 934 may be configured for transmission at the same time. In this example, LTE CRS collides with a single PDCCH DMRS. The gNB 120A may puncture each of the PDCCH DMRS and thus, the punctured PDCCH DMRS may not actually be transmitted to the UE 110. In this example, all of the PDCCH DMRS are punctured despite only one of the PDCCH DMRS RE colliding with LTE CRS. The UE 110 may also perform rate matching and puncture all of the PDCCH DMRS within the symbol.

In some exemplary embodiments, when all of the PDCCH DMRS in a symbol are punctured, the PDCCH DMRS REs that do not collide with LTE CRS RE may be replaced by NR PDCCH data REs. For instance, in example 930, only the PDCCH DMRS on subcarrier 5 collides with LTE CRS but all of the PDCCH DMRS within the symbol are punctured. The gNB 120A may transmit PDCCH data on the REs of subcarriers 1 and 9 instead of the PDCCH DMRS that is shown in FIG. 9. In other embodiments, nothing is transmitted on the PDCCH DMRS REs that do not collide with LTE CRS. For instance, in example 930, only the PDCCH DMRS on subcarrier 5 collides with LTE CRS but all of the PDCCH DMRS within the symbol are punctured. The gNB 120A may transmit neither PDCCH DMRS nor PDCCH data on the REs of subcarriers 1 and 9 instead of the PDCCH DMRS that is shown in FIG. 9.

According to some aspects, all of the PDCCH DMRS within a symbol where at least one PDCCH DMRS collides with LTE CRS may be punctured (e.g., example 930) only when certain conditions are present. Otherwise, the gNB 120A may only puncture the PDCCH DMRS that collides with the LTE CRS (e.g., example 920) or the gNB 120A may not puncture any of the PDCCH DMRS (e.g., example 910). To an example, for a resource element group (REG) bundle in which there is at least one NR PDCCH DMRS RE colliding with LTE CRES, the DMRS from the REG bundle that do not collide with DMRS may be punctured when the REG bundle is used for the transparent PDCCH subband (e.g., frequency selective precoding). In another example, the DMRS from the REG bundle that do not collide with DMRS may be punctured when the precoderGranularity IE in the ControlResourceSet IE is configured as “allContiguousRBs” and the REG bundle size contains all the REs in the ControlResourceSet. In a further example, the DMRS from the REG bundle that do not collide with DMRS may be punctured when the precoderGranularity IE in the ControlResourceSet IE is configured as “sameAsREG-bundle” and if the cce-REG-MappingType IE in ControlResourceSet IE is configure as “nonInterleaved” or if the cce-REG-MappingType IE in ControlResourceSet IE is configure as “interleaved” and the REG bundle size is configured by the reg-BundleSize IE in the ControlResourceSet IE.

According to other aspects, the direct current (DC) carrier may provide the basis for whether or not the UE 110 performs PDCCH rate matching around LTE CRS. Those skilled in the art will understand that the LTE DC may cause a one tone shift for NR since LTE punctures the LTE DC while NR does not puncture NR DC. Accordingly, if the UE 110 is required to perform NR PDCCH rate matching around LTE CRS, the corresponding NR CORESET may not overlap the LTE DC in the frequency domain. Instead, the NR CORESET may be completely above the LTE DC in the frequency domain or completely below the LTE DC in the frequency domain.

In other aspects, the subcarrier spacing (SCS) may provide the basis for whether or not the UE 110 performs PDCCH rate matching around LTE CRS. In some embodiments, the UE 110 may be required to rate match around LTE CRS during PDCCH reception only when NR PDCCH is configured with 15 kilo hertz (kHz) SCS.

In further aspects, when NR PDCCH is configured to rate match around LTE CRS, for the control channel element (CCE) that has one or multiple or all of the DMRS REs punctured due to LTE CRS, the CCS may be considered in the PDCCH processing complexity in terms of the maximum number of non-overlapping CCEs that the UE 110 may support. In other embodiments, when NR PDCCH is configured to rate match around LTE CRS, for the control channel element (CCE) that has one or multiple or all of the DMRS REs punctured due to LTE CRS, the CCE is not considered in the PDDCH processing complexity in terms of the maximum number of non-overlapping CCEs that the UE 110 may support.

### EXAMPLES

In a first example, a method performed a user equipment (UE), comprising receiving information associated with downlink reference signals for a first radio access technology (RAT), wherein the first RAT is different than a currently serving second RAT, identifying reference signal occasions for the downlink reference signal and receiving downlink control information (DCI) from the second RAT via a physical downlink control channel (PDCCH), wherein one or more DCI and one or more reference signal occasions occupy a same symbol.

In a second example, the method of the first example, further comprising identifying a type of search space for the PDCCH, when the type of search space is a common search space (CSS), restricting rate matching around the downlink reference signal of the first RAT and when the type of search space is a UE specific search space (USS), performing rate matching around the downlink reference signals of the first RAT.

In a third example, the method of the first example, further comprising receiving a radio resource control (RRC) SearchSpace information element (IE), wherein the SearchSpace IE indicates whether the UE is to perform rate matching around the downlink reference signals of the first RAT for a corresponding search space.

In a fourth example, the method of the first example, further comprising receiving a radio resource control (RRC) message comprising an information element (IE), wherein the IE is one of a PDCCH-Config IE or a PDCCH-ConfigCommon IE and wherein the IE indicates whether the UE is to perform rate matching around the downlink reference signals of the first RAT for a corresponding search space.

In a fifth example, the method of the first example, wherein the UE is configured to perform rate matching around one or more downlink reference signal patterns per SearchSpace information element (IE).

In a sixth example, the method of the first example, further comprising receiving a radio resource control (RRC) message configuring more than one downlink reference signal patterns and receiving a medium access control (MAC) control element (CE) configured to activate and deactivate the performance of rate matching around each of the more than one downlink reference signal patterns.

In a seventh example, the method of the sixth example, wherein the MAC CE comprises a bitmap and wherein each bit of the bitmap corresponds to a different downlink reference signal pattern.

In an eighth example, the method of the first example, further comprising identifying one or more PDCCH data resource elements (REs) that collide with a downlink reference signal and puncturing each of the identified one or more PDCCH data REs.

In a ninth example, the method of the first example, further comprising identifying one or more PDCCH demodulation reference signal (DMRS) resource elements (REs) in a same symbol or slot that each collide with a different downlink reference signal.

In a tenth example, the method of the ninth example, wherein at least one PDCCH DMRS RE in the same symbol or slot does not collide with a downlink reference signal and wherein all of the PDCCH DMRS REs in the same symbol or slot are punctured.

In an eleventh example, the method of the tenth example, wherein PDCCH data is transmitted in place of the at least one PDCCH DMRS RE in the same symbol or slot that does not collide with the downlink reference signal.

In a twelfth example, the method of the tenth example, wherein performing puncturing of the all the PDCCH DMRS REs in the same symbol or slot is restricted to a resource element group (REG) in which there is at least one PDCCH DMRS colliding with the downlink reference signal.

In a thirteenth example, the method of the twelfth example, wherein performing puncturing of the all the PDCCH DMRS REs in the same symbol or slot is further restricted one or more of the following predetermined conditions i) the REG bundle is used for a transparent PDCCH subband, ii) a precoder granularity is configured as all contiguous resource blocks and iii) the precoder granularity is configured as same as REG bundle.

In a fourteenth example, the method of the ninth example, wherein at least one PDCCH DMRS RE in the same symbol or slot does not collide with a downlink reference signal and wherein the identified one or more DMRS REs are punctured.

In a fifteenth example, the method of the first example, wherein PDCCH rate matching around the downlink reference signals is configured to be performed when a control resource set (CORESET) does not overlap in a frequency domain with a direct current (DC) carrier of the first RAT and wherein PDCCH rate matching around the downlink reference signals is restricted from being performed when the CORESET overlaps in the frequency domain with the DC carrier of the first RAT.

In a sixteenth example, the method of the first example, further comprising puncturing one or more demodulation reference signal (DMRS) of a control channel element (CCE), wherein the CCE is considered for a PDCCH processing complexity when determining a maximum number of non-overlapping CCEs that the UE may support.

In a seventeenth example, the method of the first example, further comprising puncturing one or more demodulation reference signal (DMRS) of a control channel element (CCE), wherein the CCE is not considered for a PDCCH processing complexity when determining a maximum number of non-overlapping CCEs that the UE may support.

In an eighteenth example, a processor of a user equipment (UE) configured to perform any of the operations of the first through seventeenth examples.

In a nineteenth example, a user equipment (UE) comprises a transceiver configured to communicate with a network and a processor communicatively coupled to the transceiver and configured to perform any of the operations of the first through seventeenth examples.

In a twentieth example, a method performed by a base station, comprising identifying reference signal occasions for a downlink reference signal of a first radio access technology (RAT) and transmitting downlink control information (DCI) to a user equipment (UE) via a physical downlink control channel (PDCCH) of a second RAT, wherein one or more DCI and one or more reference signal occasions occupy a same symbol.

In a twenty first example, the method of the twentieth example, further comprising transmitting a radio resource control (RRC) SearchSpace information element (IE) to the UE, wherein the SearchSpace IE indicates whether the UE is to perform rate matching around the downlink reference signals of the first RAT for a corresponding search space.

In a twenty second example, the method of the twentieth example, further comprising transmitting a radio resource control (RRC) message comprising an information element (IE) to the UE, wherein the IE is one of a PDCCH-Config IE or a PDCCH-ConfigCommon IE and wherein the IE indicates whether the UE is to perform rate matching around the downlink reference signals of the first RAT for a corresponding search space.

In a twenty third example, the method of the twentieth example, further comprising transmitting a radio resource control (RRC) message to the UE configuring more than one downlink reference signal patterns and transmitting a medium access control (MAC) control element (CE) to the UE configured to activate and deactivate the performance of rate matching by the UE around each of the more than one downlink reference signal patterns, wherein the MAC CE comprises a bitmap and wherein each bit of the bitmap corresponds to a different downlink reference signal pattern.

In a twenty fourth example, the method of the twentieth example, further comprising identifying one or more PDCCH data resource elements (REs) that collide with a downlink reference signal and puncturing each of the identified one or more PDCCH data REs.

In a twenty fifth example, the method of the twentieth example, further comprising identifying one or more PDCCH demodulation reference signal (DMRS) resource elements (REs) in a same symbol or slot that each collide with a different downlink reference signal.

In a twenty sixth example, the method of the twenty fifth example, wherein at least one PDCCH DMRS RE in the same symbol or slot does not collide with a downlink reference signal and wherein all of the PDCCH DMRS REs in the same symbol or slot are punctured.

In a twenty seventh example, the method of the twenty sixth example, wherein PDCCH data is transmitted in place of the at least one PDCCH DMRS RE in the same symbol or slot that does not collide with the downlink reference signal.

In a twenty eighth example, the method of the twenty sixth example, wherein performing puncturing of the all the PDCCH DMRS REs in the same symbol or slot is restricted to a resource element group (REG) in which there is at least one PDCCH DMRS colliding with the downlink reference signal.

In an twenty ninth example, a processor of a base station configured to perform any of the operations of the twentieth through twenty eighth examples.

In a thirtieth example, a base station comprises a transceiver configured to communicate with a user equipment (UE) and a processor communicatively coupled to the transceiver and configured to perform any of the operations of the twentieth through twenty eighth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A processor of a user equipment (UE) configured to perform operations comprising:
receiving information associated with downlink reference signals for a first radio access technology (RAT), wherein the first RAT is different than a currently serving second RAT;
identifying reference signal occasions for the downlink reference signal; and
receiving downlink control information (DCI) from the second RAT via a physical downlink control channel (PDCCH), wherein one or more DCI and one or more reference signal occasions occupy a same symbol.

2. The processor of claim 1, the operations further comprising:
identifying a type of search space for the PDCCH;
when the type of search space is a common search space (CSS), restricting rate matching around the downlink reference signal of the first RAT; and
when the type of search space is a UE specific search space (USS), performing rate matching around the downlink reference signals of the first RAT.

3. The processor of claim 1, the operations further comprising:
receiving a radio resource control (RRC) SearchSpace information element (IE), wherein the SearchSpace IE indicates whether the UE is to perform rate matching around the downlink reference signals of the first RAT for a corresponding search space.

4. The processor of claim 1, the operations further comprising:
receiving a radio resource control (RRC) message comprising an information element (IE), wherein the IE is one of a PDCCH-Config IE or a PDCCH-ConfigCommon IE and wherein the IE indicates whether the UE is to perform rate matching around the downlink reference signals of the first RAT for a corresponding search space.

5. The processor of claim 1, wherein the UE is configured to perform rate matching around one or more downlink reference signal patterns per SearchSpace information element (IE).

6. The processor of claim 1, the operations further comprising:
receiving a radio resource control (RRC) message configuring more than one downlink reference signal patterns; and
receiving a medium access control (MAC) control element (CE) configured to activate and deactivate the performance of rate matching around each of the more than one downlink reference signal patterns.

7. The processor of claim 6, wherein the MAC CE comprises a bitmap and wherein each bit of the bitmap corresponds to a different downlink reference signal pattern.

8. The processor of claim 1, the operations further comprising:
identifying one or more PDCCH data resource elements (REs) that collide with a downlink reference signal; and
puncturing each of the identified one or more PDCCH data REs.

9. The processor of claim 1, the operations further comprising:
identifying one or more PDCCH demodulation reference signal (DMRS) resource elements (REs) in a same symbol or slot that each collide with a different downlink reference signal.

10. The processor of claim 9, wherein at least one PDCCH DMRS RE in the same symbol or slot does not collide with a downlink reference signal and wherein all of the PDCCH DMRS REs in the same symbol or slot are punctured.

11. The processor of claim 10, wherein PDCCH data is transmitted in place of the at least one PDCCH DMRS RE in the same symbol or slot that does not collide with the downlink reference signal.

12. The processor of claim 10, wherein performing puncturing of the all the PDCCH DMRS REs in the same symbol or slot is restricted to a resource element group (REG) in which there is at least one PDCCH DMRS colliding with the downlink reference signal.

13. The processor of claim 12, wherein performing puncturing of the all the PDCCH DMRS REs in the same symbol or slot is further restricted one or more of the following predetermined conditions i) the REG bundle is used for a transparent PDCCH subband, ii) a precoder granularity is configured as all contiguous resource blocks and iii) the precoder granularity is configured as same as REG bundle.

14. The processor of claim 9, wherein at least one PDCCH DMRS RE in the same symbol or slot does not collide with a downlink reference signal and wherein the identified one or more DMRS RES are punctured.

15. A processor of a base station configured to perform operations comprising:
identifying reference signal occasions for a downlink reference signal of a first radio access technology (RAT); and
transmitting downlink control information (DCI) to a user equipment (UE) via a physical downlink control channel (PDCCH) of a second RAT, wherein one or more DCI and one or more reference signal occasions occupy a same symbol.

16. The processor of claim 15, the operations further comprising:
transmitting a radio resource control (RRC) SearchSpace information element (IE) to the UE, wherein the SearchSpace IE indicates whether the UE is to perform rate matching around the downlink reference signals of the first RAT for a corresponding search space.

17. The processor of claim 15, the operations further comprising:
transmitting a radio resource control (RRC) message comprising an information element (IE) to the UE, wherein the IE is one of a PDCCH-Config IE or a PDCCH-ConfigCommon IE and wherein the IE indicates whether the UE is to perform rate matching around the downlink reference signals of the first RAT for a corresponding search space.

18. The processor of claim 15, the operations further comprising:
transmitting a radio resource control (RRC) message to the UE configuring more than one downlink reference signal patterns; and
transmitting a medium access control (MAC) control element (CE) to the UE configured to activate and deactivate the performance of rate matching by the UE around each of the more than one downlink reference signal patterns, wherein the MAC CE comprises a bitmap and wherein each bit of the bitmap corresponds to a different downlink reference signal pattern.

19. The processor of claim 15, the operations further comprising:
identifying one or more PDCCH data resource elements (REs) that collide with a downlink reference signal; and
puncturing each of the identified one or more PDCCH data REs.

20. The processor of claim 15, the operations further comprising:
identifying one or more PDCCH demodulation reference signal (DMRS) resource elements (REs) in a same symbol or slot that each collide with a different downlink reference signal.
